(19) United States
(12) Patent Application Publication
(10) Pub. No.: US 2025/0303572 A1
(43) Pub. Date: Oct. 2, 2025

(54) Control Device And Control Method

(71) Applicant: SEIKO EPSON CORPORATION, Tokyo (JP)

(72) Inventors: Takeshi OKAMOTO, Matsumoto (JP); Hiroki MURAKAMI, Matsumoto (JP)

(21) Appl. No.: 19/090,918

(22) Filed: Mar. 26, 2025

(30) Foreign Application Priority Data
Mar. 27, 2024 (JP) 2024-052397

(51) Int. Cl. B25J 9/16; B25J 13/08

(52) U.S. Cl. CPC B25J 9/1676; B25J 9/1653; B25J 13/089

(57) ABSTRACT

A control device includes an acquisition section that acquires first information related to a tool mounted on a tip end section of a robot arm among a plurality of tools; a judgment section that performs an acceptance judgment on whether the first information acquired by the acquisition section matches second information that is related to the tool and that was set in advance; a drive control section that controls driving of the robot arm to start an operation of the robot arm when the judgment section judges that the first information and the second information match each other; and a notification signal generation section that notifies an error when the judgment section judges that the first information and the second information do not match.

The present application is based on, and claims priority from JP Application Serial Number 2024-052397, filed Mar. 27, 2024, the disclosure of which is hereby incorporated by reference herein in its entirety.

### BACKGROUND

### 1. Technical Field

The present disclosure relates to a control device and a control method.

### 2. Related Art

In recent years, in order to improve the efficiency and uniformity of work, for example, as shown in JP-A-1-16395, work such as manufacturing, processing, assembly is performed by a robot including a robot arm. In such a robot, for example, various contrivances have been made so that the robot arm does not unintentionally come into contact with an obstacle. For example, in a robot described in JP-A-1-16395, an operation prohibition region in which entry of a robot arm is prohibited is set around the robot, and the robot arm is driven so as not to enter the operation prohibition region, thereby preventing unintentional contact of the robot arm with an obstacle.

However, in the robot described in JP-A-1-16395, even if the operation prohibition region is set, when the robot is moved, if an operator makes a mistake in a setting of the type and shape of a tool mounted on a tip end section of the robot arm, a position of a control point set in the tool, or the like, or a setting is inappropriate, the tool may enter the operation prohibition region, which may cause unintentional contact of the robot arm with the obstacle. In the related art, sufficient contrivance has not been made to prevent such a setting error or an inappropriate setting.

### SUMMARY

A control device of the present disclosure includes an acquisition section that acquires first information related to a tool mounted on a tip end section of a robot arm among a plurality of tools; a judgment section that performs an acceptance judgment on whether the first information acquired by the acquisition section matches second information that is related to the tool and that was set in advance; a drive control section that controls driving of the robot arm to start an operation of the robot arm when the judgment section judges that the first information and the second information match each other; and a notification signal generation section that notifies an error when the judgment section judges that the first information and the second information do not match.

A control method of the present disclosure includes an acquisition step of acquiring first information related to a tool mounted on a tip end section of a robot arm among a plurality of tools and a judgment step of judging whether the first information acquired in the acquisition step matches second information that is related to the tool and that was set in advance, wherein when matching the first information and the second information is judged in the judgment step, a driving step of controlling driving of the robot arm so as to start an operation of the robot arm is executed and when not matching the first information and the second information is judged in the judgment step, a notification step of notifying an error is executed.

### BRIEF DESCRIPTION OF THE DRAWINGS

FIG. 1 is a diagram showing an overall configuration of a robot system including a first embodiment of a control device of the present disclosure.

FIG. 2 is a block diagram of the robot system shown in FIG. 1.

FIG. 3 is a perspective view of a tool mounted on a robot arm.

FIG. 4 is a diagram showing an example of a teaching screen.

FIG. 5 is a diagram showing an example of a confirmation screen.

FIG. 6 is a diagram showing an example of the confirmation screen.

FIG. 7 is a diagram showing an example of an execution screen.

FIG. 8 is a diagram showing an example of a notification screen.

FIG. 9 is a flowchart for explaining an example of a control method of the present disclosure.

FIG. 10 is a diagram showing an example of a program creation screen of a second embodiment of the control device of the present disclosure.

FIG. 11 is a diagram showing an example of the program creation screen of the second embodiment of the control device of the present disclosure.

### DESCRIPTION OF EMBODIMENTS

Hereinafter, a control device and a control method of the present disclosure will be described in detail based on preferred embodiments shown in the accompanying drawings.

### First Embodiment

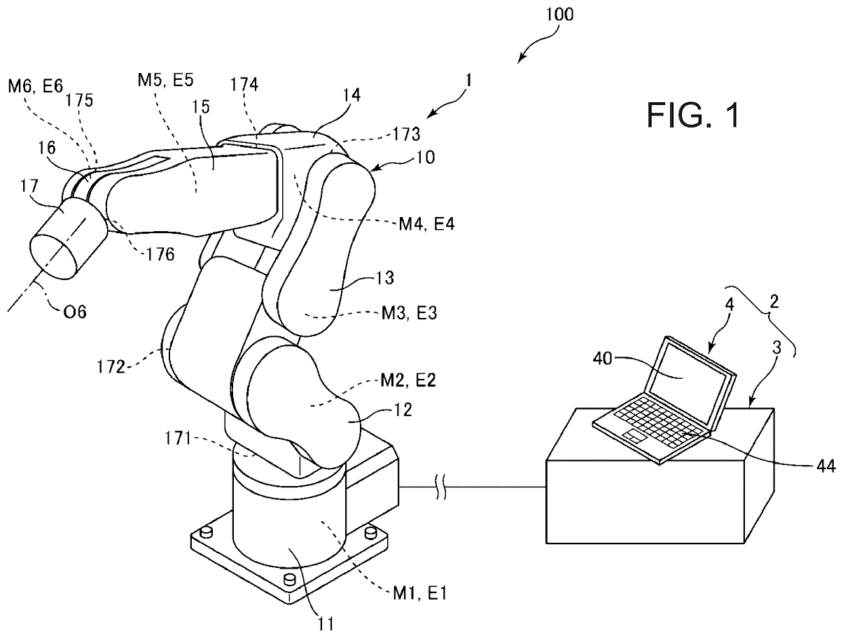

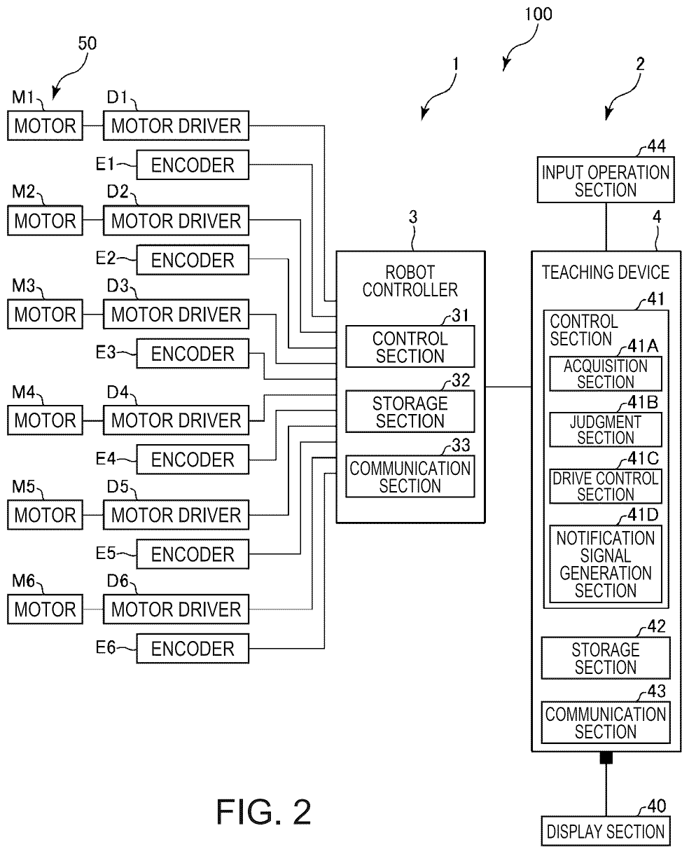

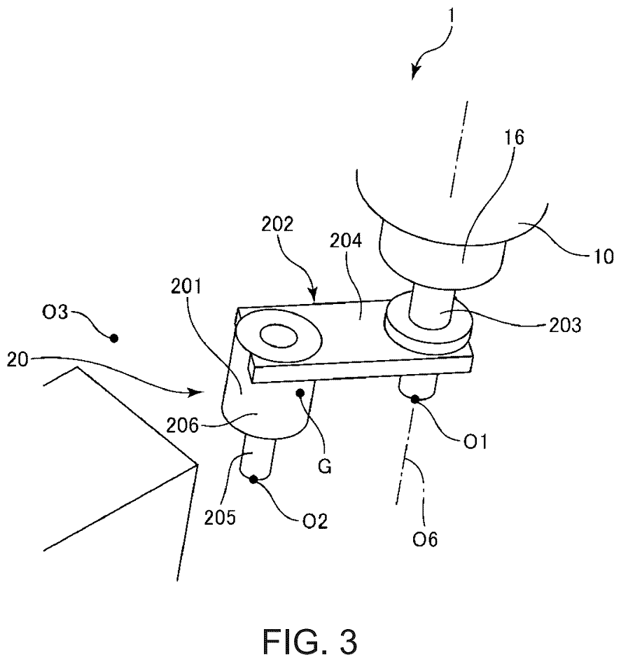

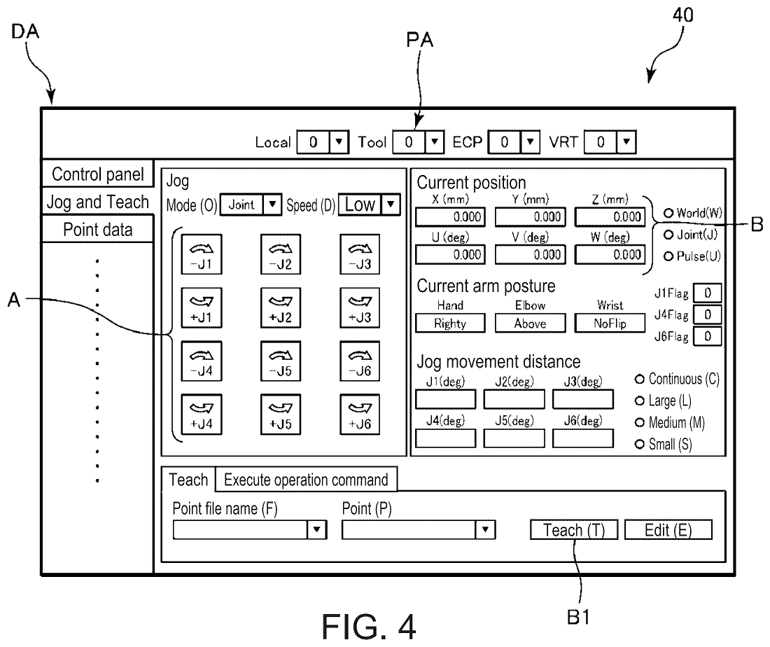

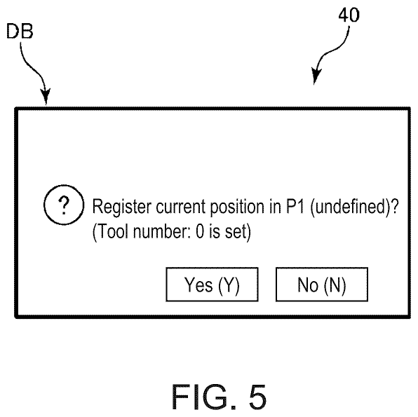

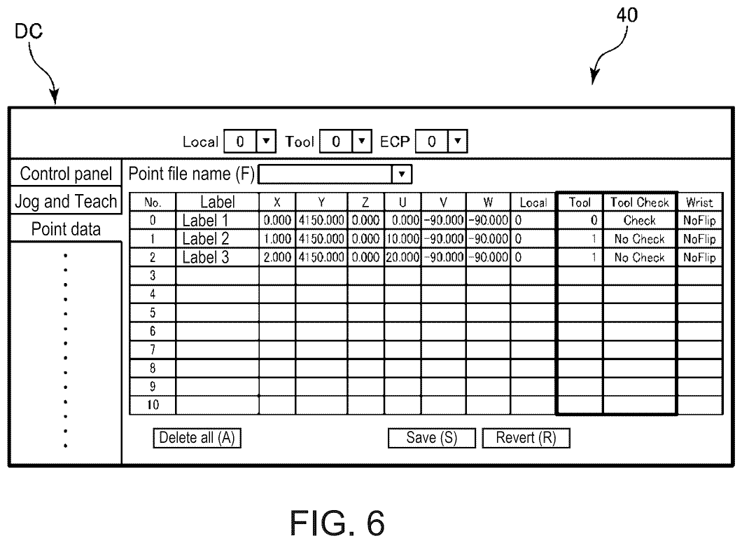

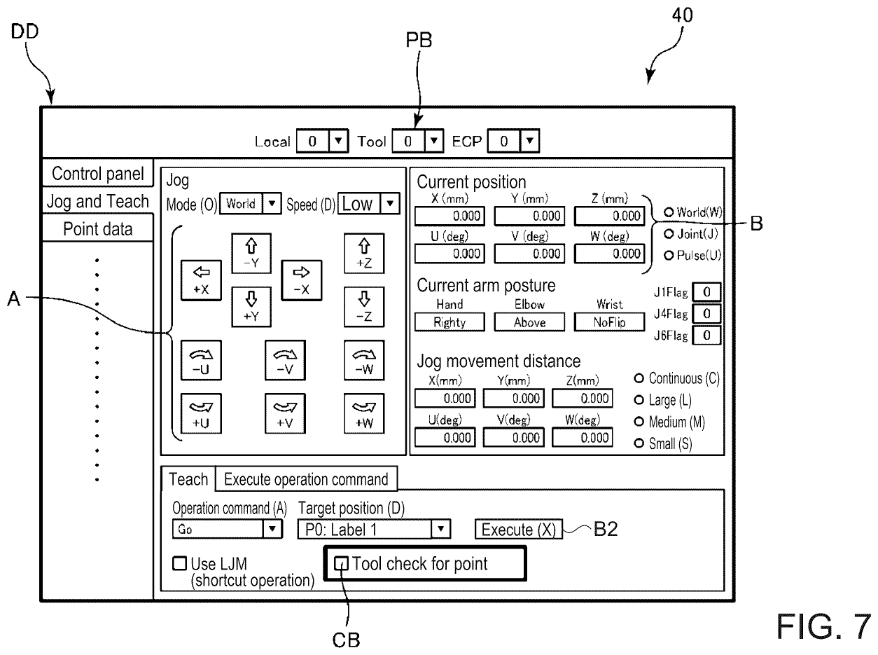

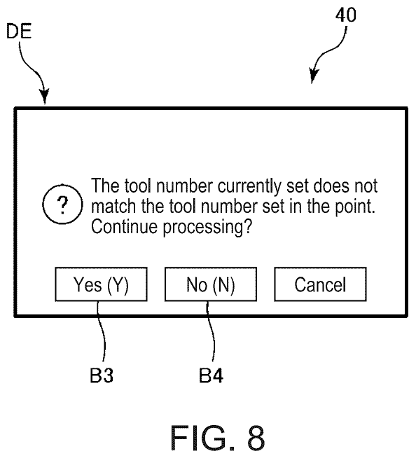

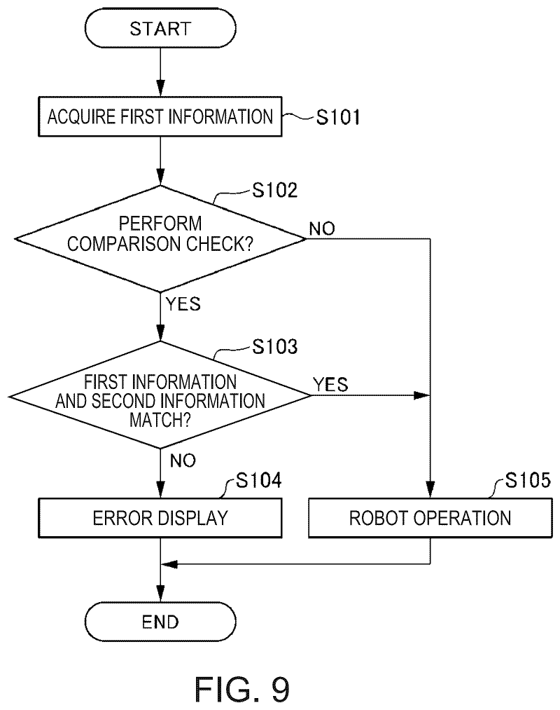

FIG. 1 is a diagram showing an overall configuration of a robot system including a first embodiment of a control device of the present disclosure. FIG. 2 is a block diagram of the robot system shown in FIG. 1. FIG. 3 is a perspective view of a tool mounted on a robot arm. FIG. 4 is a diagram showing an example of a teaching screen. FIG. 5 is a diagram showing an example of a confirmation screen. FIG. 6 is a diagram showing an example of the confirmation screen. FIG. 7 is a diagram showing an example of an execution screen. FIG. 8 is a diagram showing an example of a notification screen. FIG. 9 is a flowchart for explaining an example of a control method of the present disclosure.

Hereinafter, for convenience of description, in a robot arm 10, a base 11 side in FIG. 1 is referred to as a “base end”, and the opposite side, that is, a tool 20 side is referred to as a “tip end”.

As shown in FIG. 1, a robot system 100 includes a robot 1 and a robot controller 3.

First, the robot 1 will be described.

The robot 1 shown in FIG. 1 is a single-arm six axes vertical articulated robot in the present embodiment and includes a base 11 and the robot arm 10. A tool 20, which is an end effector, can be mounted on a tip end section of the robot arm 10. The tool 20 may be a constituent component of the robot 1, and may not be a member separate from the robot 1, that is, it may not be a constituent component of the robot 1.

The robot 1 is not limited to the shown configuration, and may be, for example, a double-arm articulated robot. The robot 1 may be a horizontal articulated robot. The robot 1 can perform various works such as transporting work, assembling work, disassembling work, painting work, and polishing work of a work object.

The base 11 is a support body that supports the robot arm 10 at the base end side in a drivable manner and is fixed to, for example, a factory floor. The robot 1 is electrically connected to the robot controller 3 via a relay cable with the base 11. The connection between the robot 1 and the robot controller 3 is not limited to a wired connection as in the configuration shown in FIG. 1, and may be, for example, a wireless connection. They may be connected via a network such as the Internet.

In the present embodiment, the robot arm 10 includes a first arm 12, a second arm 13, a third arm 14, a fourth arm 15, a fifth arm 16, and a sixth arm 17, and these arms are connected in this order from a base 11 side toward a tip end side. The number of arms included in the robot arm 10 is not limited to six, and may be, for example, one, two, three, four, five, or seven or more. The size, such as the total length of each arm, is not particularly limited and can be appropriately set.

The base 11 and the first arm 12 are connected to each other via a first joint 171. The first arm 12 is rotatable with respect to the base 11 about a first rotation axis extending in a Z-axial direction as a rotation center. In this way, the first rotation axis coincides with the normal line of a floor surface to which the base 11 is fixed, and the entire robot arm 10 can rotate about the first rotation axis in either the forward direction or the reverse direction.

The first arm 12 and the second arm 13 are connected to each other via a second joint 172. The second arm 13 is rotatable with respect to the first arm 12 about a second rotation axis extending in the horizontal direction as a rotation center.

The second arm 13 and the third arm 14 are connected to each other via a third joint 173. The third arm 14 is rotatable with respect to the second arm 13 about a third rotation axis extending in the horizontal direction as a rotation center. The third rotation axis is parallel to the second rotation axis.

The third arm 14 and the fourth arm 15 are connected to each other via a fourth joint 174. The fourth arm 15 is rotatable with respect to the third arm 14 about a fourth rotation axis that is parallel to a central axis direction of the third arm 14 as a rotation center. The fourth rotation axis is orthogonal to the third rotation axis.

The fourth arm 15 and the fifth arm 16 are connected to each other via a fifth joint 175. The fifth arm 16 is rotatable about a fifth rotation axis as a rotation center with respect to the fourth arm 15. The fifth rotation axis is orthogonal to the fourth rotation axis.

The fifth arm 16 and the sixth arm 17 are connected to each other via a sixth joint 176. The sixth arm 17 is rotatable about a sixth rotation axis O6 as a rotation center with respect to the fifth arm 16. The sixth rotation axis O6 is orthogonal to the fifth rotation axis.

The sixth arm 17 is a robot tip end section positioned on the most tip end side in the robot arm 10. The sixth arm 17 can be displaced together with the tool 20 by driving of the robot arm 10.

In the following description, the first arm 12, the second arm 13, the third arm 14, the fourth arm 15, the fifth arm 16, and the sixth arm 17 will be collectively referred to as “arm”, and the first joint 171, the second joint 172, the third joint 173, the fourth joint 174, the fifth joint 175, and the sixth joint 176 will be collectively referred to as “joint”.

The robot 1 includes a motor M1, a motor M2, a motor M3, a motor M4, a motor M5, and a motor M6 as drive sections, and an encoder E1, an encoder E2, an encoder E3, an encoder E4, an encoder E5, an encoder E6. The motor M1 is incorporated in the first joint 171 and rotates the first arm 12 about the first rotation axis with respect to the base 11. The motor M2 is incorporated in the second joint 172 and relatively rotates the first arm 12 and the second arm 13 about the second rotation axis. The motor M3 is incorporated in the third joint 173 and relatively rotates the second arm 13 and the third arm 14 about the third rotation axis. The motor M4 is incorporated in the fourth joint 174 and relatively rotates the third arm 14 and the fourth arm 15 about the fourth rotation axis. The motor M5 is incorporated in the fifth joint 175, and relatively rotates the fourth arm 15 and the fifth arm 16 about the fifth rotation axis. The motor M6 is incorporated in the sixth joint 176 and relatively rotates the fifth arm 16 and the sixth arm 17 about the sixth rotation axis O6.

The encoder E1 is incorporated in the first joint 171 and detects a position of the motor M1. The encoder E2 is incorporated in the second joint 172 and detects a position of the motor M2. The encoder E3 is incorporated in the third joint 173 and detects a position of the motor M3. The encoder E4 is incorporated in the fourth joint 174 and detects a position of the motor M4. The encoder E5 is incorporated in the fifth joint 175 and detects a position of the motor M5. The encoder E6 is incorporated in the sixth joint 176 and detects a position of the motor M6. The term “detect a position” used herein refers to detection of a rotation angle of a motor, that is, a rotation amount including forward and reverse rotation and an angular velocity, and the detected information is referred to as “position information”.

As shown in FIG. 2, a motor driver D1 to a motor driver D6 are respectively connected to the corresponding motor M1 to the motor M6, to control driving of each of these motors. The motor driver D1 to the motor driver D6 are incorporated in the first joint 171, the second joint 172, the third joint 173, the fourth joint 174, the fifth joint 175, and the sixth joint 176, respectively.

The encoder E1 to the encoder E6, the motor M1 to the motor M6, and the motor driver D1 to the motor driver D6 are each electrically connected to the robot controller 3. The position information of the motor M1 to the motor M6 detected by the encoder E1 to the encoder E6, that is, the rotation amount, is transmitted to the robot controller 3 as an electrical signal. Then, based on this position information, the robot controller 3 outputs a control signal to the motor driver DI to the motor driver D6 shown in FIG. 2, and drives the motor M1 to the motor M6. That is, controlling the robot arm 10 means controlling driving of the motor M1 to the motor M6 to control operations of the first arm 12 to the sixth arm 17 belonging to the robot arm 10.

As shown in FIG. 3, the tool 20 is installed at the tip end section of the robot arm 10, that is, a tip end section of the sixth arm 17. The tool 20 is selected and mounted according to a work content, with the type, shape, and size appropriate for the work. In the shown configuration, the tool 20 includes a screwdriver 201 and a holder 202 that holds the screwdriver 201. However, in the present disclosure, the tool 20 is not limited to the screwdriver 201, and may be, for example, a drill, a tap, a hand, or the like.

The screwdriver 201 includes a shaft section 205 made of hard material and a holding section 206 that holds the shaft section 205. The shaft section 205 is spaced a predetermined distance from the sixth rotation axis O6 and extends in a direction parallel to the sixth rotation axis O6.

The holder 202 includes a shaft 203 and a plate member 204 fixed to the shaft 203. The shaft 203 is fixed to the tip end section of the sixth arm 17. The shaft 203 is provided concentrically with the sixth rotation axis O6. The plate member 204 has an elongated shape extending in a direction orthogonal to the shaft 203, and includes one end section fixed to the shaft 203 and the other end section to which the screwdriver 201 is fixed. Therefore, the screwdriver 201 is held at a position eccentric from the sixth rotation axis O6. The centroid G of the tool 20 is positioned at a position eccentric from the sixth rotation axis O6.

Next, a control device 2 will be described.

As shown in FIGS. 1 and 2, the control device 2 includes the robot controller 3 and a teaching device 4.

As shown in FIG. 1, the robot controller 3 is installed at a position away from the robot 1 in the present embodiment. However, the present disclosure is not limited to this configuration, and the robot controller 3 may be incorporated in the base 11. The robot controller 3 has a function of controlling driving of the robot 1, and is electrically connected to each section of the robot 1 described above. As shown in FIG. 2, the robot controller 3 includes a control section 31, a storage section 32, and a communication section 33. These sections are communicably connected to each other via, for example, a bus.

The control section 31 reads and executes various programs such as an operation program stored in the storage section 32. The control section 31 is constituted by at least one processor such as a central processing unit (CPU). Signals generated by the control section 31 are transmitted to each section of the robot 1 via the communication section 33, and signals from each section of the robot 1 are received by the control section 31 via the communication section 33. By this, the robot arm can execute predetermined work under a predetermined condition. The signal generated by the control section 31 can also be transmitted to the teaching device 4 via the communication section 33.

The storage section 32 stores various programs and the like executed by the control section 31. Specifically, the storage section 32 stores a program and the like for executing the control method of the present disclosure. Examples of the storage section 32 include a volatile memory such as a random access memory (RAM), a nonvolatile memory such as a read only memory (ROM), and a detachable external storage device. A part or the whole of a program for executing the control method of the present disclosure is stored in the storage section 32.

The communication section 33 transmits and receives signals to and from the robot 1 and the teaching device 4 using an external interface such as a wired local area network (LAN) or a wireless LAN. In this case, communication may be performed via a server (not shown), or via a network such as the Internet.

As shown in FIG. 1 and FIG. 2, the teaching device 4 is a device for teaching an operation program to robot 1, and is constituted by a laptop personal computer including a display section 40 and an input operation section 44.

The input operation section 44 is composed of a keyboard and a mouse (not shown), which are operated by an operator to input various kinds of information. The display section 40 is composed of, for example, a liquid crystal, an organic electroluminescence, or the like, and can display various display screens in color or monochrome. The display section 40 displays a teaching screen DA, a confirmation screen DB, a confirmation screen DC, an execution screen DD, a notification screen DE, and the like, which will be described later. The teaching screen DA, the confirmation screen DB, the confirmation screen DC, the execution screen DD, and the notification screen DE may be displayed on the display section 40 simultaneously, or may be displayed sequentially or at appropriate times by performing an image switching operation or the like. The image switching operation is performed using the input operation section 44.

The teaching device 4 is not limited to a laptop personal computer, and may be a desktop personal computer, a tablet-type device, or the like. Here, when the teaching device 4 is a tablet-type device or the like, a touchscreen may be used as the input operation section 44. The display section is not limited to the display section 40, and may be, for example, an image projection section that projects various images using a projector.

The control section 41 shown in FIG. 2 is constituted by at least one processor such as a central processing unit (CPU), for example, and reads and executes various programs stored in the storage section 42. The control section 41 has a function of receiving an operation by the input operation section 44 and controlling an operation of the display section 40. Controlling the operation of the display section 40 means generating image data of the teaching screen DA, the confirmation screen DB, the confirmation screen DC, the execution screen DD, the notification screen DE, and the like, and displaying the image data on the display section 40.

The control section 41 includes an acquisition section 41A, a judgment section 41B, a drive control section 41C, and a notification signal generation section 41D. The acquisition section 41A executes an acquisition step (to be described later), the judgment section 41B executes a judgment step (to be described later), the drive control section 41C generates a drive signal to permit execution of a driving step (to be described later), and the notification signal generation section 41D executes a notification step (to be described later). That is, among the processors included in the control section 41, a processor that executes the acquisition step is the acquisition section 41A, a processor that executes the judgment step is the judgment section 41B, a processor that executes the driving step is the drive control section 41C, and a processor that executes the notification step is the notification signal generation section 41D.

The storage section 42 stores various programs or the like that can be executed by the control section 41. Examples of the storage section 42 include a volatile memory such as a random access memory (RAM), a nonvolatile memory such as a read only memory (ROM), and a detachable external storage device. A part or the whole of a program for executing the control method of the present disclosure is stored in the storage section 42. The program for executing the control method of the present disclosure may be stored in an external storage device.

The communication section 43 includes an interface circuit and transmits and receives signals to and from the robot controller 3 using an external interface such as a wired local area network (LAN) or a wireless LAN. In this case, communication may be performed via a server (not shown), or via a network such as the Internet. The communication section 43 transmits information related to an operation program stored in the storage section 42 to the robot controller 3. The communication section 43 can also receive information stored in the storage section 32 and store the information in the storage section 42.

The control device 2 performs teaching of point data that is data of a control point, that is, a point (position information of the robot arm 10), by an operation of an operator, and then executes an operation program using the point data created by the teaching. Before the operation program is actually executed, first information related to the tool 20 set in the robot arm 10 needs to match information related to the tool 20 set when point data is created in teaching, that is, second information that is related to the tool 20 and that was set in advance. If the two do not match, for example, the robot arm 10 may perform an unexpected operation. In the present disclosure, the above-described problem is solved by the following configurations. This will be described below. First, a case where teaching is performed will be described.

When teaching is performed, point data is created using the teaching device 4. That is, the input operation section 44 of the teaching device 4 is operated to associate point data of the robot arm 10 with position information of the origin of a predetermined coordinate system, and this is stored in the storage section 32. Point data includes position data of the robot arm 10 in a predetermined coordinate system. Position information of the origin of a predetermined coordinate system is, for example, the origin set for each tool. That is, point data of the robot arm 10 and information indicating the type of tool may be stored in the storage section 32 in association with each other. Information indicating the type of tool may be a tool number set for each tool.

In teaching, first, a coordinate system to be used is set. This selection is set by selecting from among a base coordinate system, a tip end coordinate system, an external coordinate system, and the like. Hereinafter, the external coordinate system will be described as an example. Position information of the origin in the external coordinate system is set. In the external coordinate system, a position of the origin can be selected and set from a plurality of positions, and in the present embodiment, as shown in FIG. 3, from three positions, an origin O1, an origin O2, and an origin O3.

An origin positioned at a tip end of the shaft 203 of the tool 20 is the origin O1, an origin positioned at a tip end of the shaft section 205 of the screwdriver 201 is the origin O2, and an origin positioned at a position a predetermined distance away from the shaft 203 of the screwdriver 201 is the origin O3. For example, the origin O3 is an origin positioned at a tip end of a tool other than the screwdriver 201, for example, a hand when the hand is attached. Here, a tool with the origin O1 as its reference is defined as tool number 0, a tool with the origin O2 as its reference is defined as tool number 1, and a tool with the origin O3 as its reference is defined as tool number 2. When performing teaching, the display section 40 displays the teaching screen DA, the confirmation screen DB, the confirmation screen DC, the execution screen DD, and the notification screen DE as shown in FIGS. 4 to 8, and in addition to these, a simulation screen of the tip end section of the robot arm 10 and the tool 20 shown in FIG. 3 may also be displayed, particularly including a simulation screen on which the origin O1, the origin O2, and the origin O3 are displayed. By this, the type and shape of the tool 20, the position of each origin, the positional relationship with the tool 20, and the like can be easily grasped, and teaching can be more easily and appropriately performed.

Such a setting can be alternatively set by performing an operation on the teaching screen DA shown in FIG. 4 according to an operation or a use. Then, plural sets of point data are created. As a method of creating point data, for example, buttons A in FIG. 4 may be operated to move the origin of the robot arm or tool 20 to a predetermined position, or coordinates may be input to input sections B representing coordinates.

Origin position information is set by operating a pull-down PA indicated as “Tool” in the teaching screen DA shown in FIG. 4 and selecting a number. Numbers selected by the pull-down PA correspond to the origin O1, the origin O2, and the origin O3, respectively. Information related to the tool 20 set by the pull-down PA, that is, information related to position information of the origin, is the second information. The information related to the tool 20 may be, for example, a tool number.

After creating point data and setting position information of the origin, when the button B1 labeled “Teach (T)” is pressed on the teaching screen DA shown in FIG. 4, information related to the tool 20 set by the pull-down PA, that is, information related to position information of the origin, is associated with point data and stored in the storage section 42 as an operation program. At this time, the confirmation screen DB as shown in FIG. 5 is displayed. The confirmation screen DB displays “Register current position in P1 (undefined)? (Tool number: 0 is set)”. Here, “P1” is one set of the point data sets, and corresponds to “Label 1” on the confirmation screen DC shown in FIG. 6.

The point data and the position information of the origin thus created can be confirmed on the confirmation screen DC shown in FIG. 6.

The confirmation screen DC is a screen that displays a list of the point data and the origin position information and allows the data to be confirmed, with “Label 1”, “Label 2” and “Label 3” rows each indicating information on each point data.

Each point data is displayed in association with the position information of the origin. The numbers shown in the “Tool” column correspond to the origin numbers. That is, number 0 of position information indicated by “Label 1” is the origin O1, number 1 of position information indicated by “Label 2” is the origin O2, and number 2 of position information indicated by “Label 3” is the origin O2.

Each piece of point data is displayed in association with information as to whether or not to perform a comparison check (to be described later). The characters “Check” or “No Check” shown in the column of “Tool Check” in the confirmation screen DC shown in FIG. 6 correspond to whether or not an acceptance judgment (to be described later) is to be performed. That is, the setting is such that the acceptance judgment is performed for “Label 1,” the acceptance judgment is not performed for “Label 2,” and the acceptance judgment is not performed for “Label 3”. Such settings can be set, for example, on the confirmation screen DC or on program creation screens DF and DG in a second embodiment (to be described later), or the like.

Next, a case where an operation program created by teaching is executed will be described.

When an operation program created by teaching is executed, for example, the execution screen DD shown in FIG. 7 is displayed on the display section 40, and an operation is performed on the execution screen DD. Specifically, a pull-down PB labeled “Tool” is operated to select a number. The numbers selected by the pull-down PB correspond to the origin O1, the origin O2, and the origin O3, respectively.

Next, the acquisition section 41A acquires information of the origin set by the pull-down PB. This is the first information related to the tool 20. The first information is information related to the tool mounted on the robot arm when the operation program is executed, in other words, position information of the origin selected when the operation program is executed.

A check box CB is displayed on the execution screen DD. After an operation of checking the check box CB is performed, when a button B2 labeled “Execute” is pressed, a judgment step by the judgment section 41B, that is, the acceptance judgment, is performed. If the button B2 labeled “Execute” is pressed without checking the check box CB, the acceptance judgment by judgment section 41B is omitted. As described above, the check box CB can be regarded as a selection section for selecting whether or not to perform the acceptance judgment by the judgment section 41B.

Next, information related to the tool 20 set in advance, that is, position information of the origin (second information) set at the time of teaching is compared with information related to the tool 20 acquired by the acquisition section 41A, that is, position information of the origin (first information) that an operator input before (approximately immediately before) an operation of the robot arm 10, and a judgment is performed as to whether they match. This judgment is performed by the judgment section 41B. The judgment section 41B performs the acceptance judgment for each of the taught point data.

When the judgment section 41B judges that position information of the origin set at the time of teaching matches position information of the origin acquired by the acquisition section 41A, the drive control section 41C transmits a drive signal for driving the robot arm 10 to the robot controller 3, and controls the drive of the robot arm 10 so as to start an operation of the robot arm 10.

When the judgment section 41B judges that position information of the origin set at the time of teaching does not match position information of the origin acquired by the acquisition section 41A, the notification signal generation section 41D notifies an error. That is, the notification signal generation section 41D generates image data of the notification screen DE as shown in FIG. 8 and causes the display section 40 to display the image data.

The notification screen DE displays a message “The tool number currently set does not match the tool number set in the point. Continue processing?”. By pressing a button B3 of “Yes (Y)” or a button B4 of “No (N)” below the message, it is possible to select whether to continue the process as it is or to reset the setting again.

As described above, since the control device 2 judges

whether position information of the origin set at the time of teaching before the start of the operation of the robot arm 10 matches position information of the origin in the upcoming operation, it is possible to prevent the robot arm 10 from being driven when they do not match. That is, it is possible to prevent the robot arm 10 from being operated in a state in which position information of the origin is different from the expected state. Therefore, it is possible to appropriately and more accurately perform the operation of the robot arm 10, and it is possible to improve work accuracy and enhance safety. For example, if a tool with the tool number 0 is attached to the tip end of the robot arm 10, but point data included in the operation program executed by the robot arm 10 is a point (position) taught using a tool with the tool number 1 at the time of teaching, when the robot arm 10 is actually moved, there is a possibility that it may arrive at an unintended point on a path not intended by an operator. As described above, the present disclosure can prevent the robot arm 10 from performing an operation different from the assumption by checking whether tool information matches before an operation of the robot arm 10.

As described above, the control device 2 includes the acquisition section 41A that acquires position information of the origin of the tool 20, which is the first information related to a tool mounted on the tip end section of the robot arm among a plurality of tools, the judgment section 41B that performs the acceptance judgment on whether the first information acquired by the acquisition section 41A matches position information of the origin of the tool 20, which is the preset second information that is related to the tool 20, the drive control section 41C that controls driving of the robot arm 10 to start an operation of the robot arm 10 when the judgment section 41B judges that the first information and the second information match each other, and the notification signal generation section 41D that notifies an error when the judgment section 41B judges that the first information and the second information do not match. By this, it is possible to prevent the operation of the robot arm 10 in a state where the information of the tool 20 is different from the expected state. Therefore, it is possible to appropriately and more accurately perform the operation of the robot arm 10, and it is possible to improve work accuracy and enhance safety.

The first information and the second information each include position information of the origin of a coordinate system set for each tool. By this, the robot arm 10 can be operated in a state where position information of the origin of the coordinate system of the first information and the second information matches. Therefore, an operation of the robot arm 10 can be performed more accurately, and the work accuracy and safety can be improved.

In the present disclosure, the first information and the second information may include information other than the position information of the origin, or may be information other than the position information of the origin.

The judgment section 41B performs an acceptance judgment for each point, which is position information of the robot arm 10 in an operation program. By this, at each point, it is possible to operate the robot arm 10 in a state where position information of the origin of a coordinate system of the first information and the second information matches.

The control device 2 includes the check box CB as the selection section for selecting whether or not to perform the acceptance judgment by the judgment section 41B. By this, the acceptance judgment can be performed only when necessary. As a result, teaching work and the like can be carried out more quickly.

In the present disclosure, the selection section may be omitted, and in this case, the acceptance judgment is always performed.

The origin of a coordinate system set for each tool is a position eccentric from the tip end section of the robot arm 10. When the tool 20 with such a shape is used, unless position information of the origin is accurately set, the tool 20 is likely to contact or collide with another object unintentionally. Therefore, by applying the tool 20 with such a shape, the effects of the present disclosure can be more significantly obtained.

In the present disclosure, the type, shape, size, and the like of the tool 20 are not particularly limited, and the position relationship of the centroid G of the tool 20 with respect to the sixth rotation axis 06 is also not limited to the above.

Next, an example of the control method of the present disclosure will be described with reference to the flowchart shown in FIG. 9. In the following description, a description will be given from a stage of executing a created operation program after the operation program is created by performing teaching.

### Step S101

First, an operator performs an operation on the execution screen DD shown in FIG. 7 using the teaching device 4, and sets position information of the origin. That is, the pull-down PB labeled “Tool” is operated, the number is selected, and any one of the origin O1, the origin O2, or the origin O3 is selected. In step S101, the acquisition section 41A acquires the first information set by the selection of the origin. This step S101 is an acquisition step.

### Step S102

Next, in step S102, it is judged whether or not to perform the comparison check, that is, whether or not to perform the acceptance judgment. The judgment is performed based on whether or not the check box CB, which is the selection section, is checked in the operation in step S101.

When it is judged in step S102 that the comparison check is to be performed, the process proceeds to step S103, and when it is judged in step S102 that the comparison check is not to be performed, the process proceeds to step S105.

### Step S103

In step S103, it is judged whether the first information and the second information match. That is, the judgment section 41B compares information related to the tool 20 that was set in advance, that is, position information (second information) of the origin set at the time of teaching, with information related to the tool 20 acquired by the acquisition section 41A, that is, position information (first information) of the origin, and judges whether or not both match.

### Step S104

When it is judged in step S103 that the first information and the second information do not match, an error is displayed on the display section 40 in step S104. That is, the notification screen DE shown in FIG. 8 is displayed. This step is executed by the notification signal generation section 41D. This step S104 is a notification step.

### Step S105

On the other hand, when it is judged in step S103 that the first information and the second information match each other, the robot 1 is operated in step S105. That is, the drive control section 41C generates a signal for driving the robot arm 10 and transmits it to the robot controller 3. This step S105 is a driving step.

As described above, the control method of the present disclosure includes the acquisition step of acquiring the first information related to the tool 20 mounted on the tip end section of the robot arm 10 (the position information of the origin of the tool 20) among a plurality of tools and the judgment step of judging whether the first information acquired in the acquisition step matches the second information that is related to the tool 20 and that was set in advance (the position information of the origin of the tool 20), wherein when matching the first information and the second information is judged in the judgment step, the driving step of controlling driving of the robot arm 10 so as to start the operation of the robot arm 10 is executed and when not matching the first information and the second information is judged in the judgment step, the notification step of notifying an error is executed. By this, it is possible to prevent the operation of the robot arm 10 in a state where the information of the tool 20 is different from the expected state. Therefore, an operation of the robot arm 10 can be performed more appropriately and more accurately, and the work accuracy and safety can be improved.

A notification of an error is not limited to an error display on the display section 40, but may be, for example, a notification by a pilot lamp lighting up or flashing, a notification by generation of sound or vibration, or a notification by refusal to operate the robot arm 10, and the like.

The control method of the present disclosure may be a configuration performed only by the robot controller 3, may be a configuration performed only by the teaching device 4, or may be a configuration performed by them sharing the tasks.

### Second Embodiment

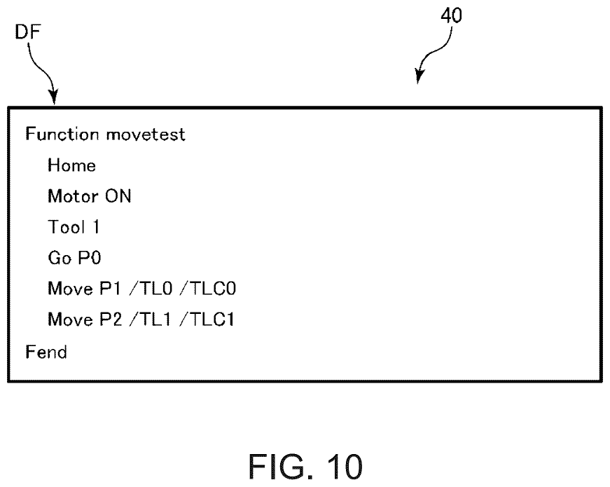

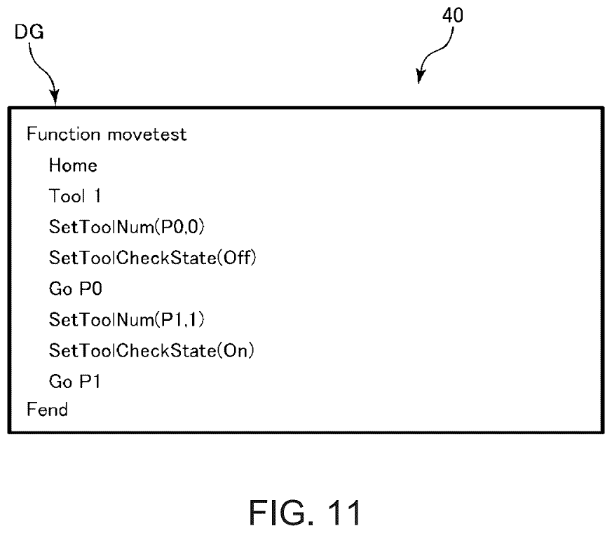

FIGS. 10 and 11 are diagrams showing an example of a program creation screen in a second embodiment of the control device of the present disclosure.

A control device and a control method according to the second embodiment of the present disclosure will be described below with reference to FIGS. 10 and 11, but the description below will mainly focus on the differences from the first embodiment, and descriptions of common points will be omitted.

In the present embodiment, information related to the tool 20 is set using a program creation screen DF shown in FIG. 10 or a program creation screen DG shown in FIG. 11. The program creation screen DF and the program creation screen DG can be appropriately displayed on the display section 40 by performing a screen switching operation or the like.

As shown in FIG. 10, the program creation screen DF creates an operation program in C language. In FIG. 10, the characters “Tool 1” indicate the type of tool, that is, a program for setting that tool 20 is used, and “Tool 1” is the first information. In FIG. 10, the characters “Move P1” is a unit operation program set to move to a position P1, and “TL0” indicates that the position P1 is point data associated with a tool with tool number 0. This “TL0” is the second information. Further, “TLC0” indicates that it is not judged whether the first information and the second information match. In FIG. 10, the characters “Move P2” is a unit operation program set to move to a position P2, and “TL1” indicates that the position P2 is point data associated with a tool with tool number 1. This “TL1” is the second information. Further, “TLC1” indicates that it is judged whether the first information and the second information match. In this case, since the first information and the second information match, an operation of the robot arm 10 is started.

In the operation program created on the program creation screen DF, “TLC0” or “TLC1” is designated for each unit operation program. Therefore, the acceptance judgment is executed in each of the unit operation programs of “Move P1” and “Move P2”.

In this way, the control device 2 performs the acceptance judgment for each unit operation program included in the operation program executed by the robot arm 10. By this, each unit operation program can be executed in a state where the first information and the second information match. Therefore, an operation of the robot arm 10 can be performed more accurately, and the work accuracy and safety can be improved.

On the program creation screen DF, information on the type of the tool 20 mounted on the tip end section of the robot arm 10, for example, information on whether the tool 20 is a screwdriver, a drill, or a tap can be set. Information related to the type of the tool 20 is the first information. That is, in the present embodiment, the first information includes information related to the type of the tool 20 and position information related to the origin of the tool 20. The second information also includes information related to the type of tool and position information related to the origin of the tool.

Here, “the type of tool” refers to the broad sense of tools corresponding to the work purpose, such as a screwdriver, a drill, and a tap, as described above, but the present disclosure is not limited to these, for example, with respect to screwdrivers, “the type of tool” may refer to an intermediate classification or a smaller classification of screwdrivers, such as flat head screwdrivers and Phillips head screwdrivers, or to a tip end shape of the screwdriver. Further, in a narrow sense, “the type of tool” may include, for example, information related to dimensions such as the thickness and length of the shaft section 205 with respect to the tool 20 being the screwdriver 201.

Since it is judged whether information of the type of the tool 20 set at the time of teaching and information of the type of tool in an operation to be executed from now on match, it is possible to prevent the robot arm 10 from being driven in a state in which they do not match.

In particular, in the present embodiment, the acceptance judgment is performed on type information of the tool 20 and position information of the origin, respectively. Even if the type of the tool 20 does not match, the position information of the origin may match, therefore, in this embodiment, such an error can be identified. Therefore, an operation of the robot arm 10 can be performed more accurately, and the work accuracy and safety can be further improved.

Thus, the first information and the second information include information related to the type of tool. By this, it is possible to perform the acceptance judgment in consideration of information of the type of the tool 20, and an operation of the robot arm 10 can be performed more accurately. That is, the robot arm 10 can be driven in a state in which the types of the tool 20 match, and further improvement in work accuracy and safety can be achieved.

As shown in FIG. 11, the program creation screen DG creates an operation program using the SPEL function. In FIG. 11, the characters “Tool 1” indicate that the origin O1 is used as the origin of a tool. That is, “Tool 1” is the first information. The character “SetToolNum(P0, 0)” indicates an unit operation program set to use the origin O1 as the origin of the tool in a point P0. This unit operation program is the second information. The characters “SetToolCheckState(Off)” indicate a unit operation program that is set not to perform the acceptance judgment. Therefore, the subsequent unit operation program “Go P0” does not perform the acceptance judgment.

The next unit operation program “SetToolNum(P1, 1)” is a unit operation program set to use the origin O2 as the origin of the tool in a point P1. This unit operation program is the second information. The characters “SetToolCheckState(On)” indicate a unit operation program set to perform the acceptance judgment. In this case, since the first information and the second information match, an operation of the robot arm 10 is started.

Even in the operation program created on the program creation screen DG, it is possible to select whether or not to perform the acceptance judgment, similarly to the first embodiment. In particular, when the program creation screen DG is set to perform the acceptance judgment, it is possible to prioritize the acceptance judgment to be performed even when the button B2 labeled “Execute” is pressed while the check box CB of the execution screen DD shown in FIG. 7 is not checked. Therefore, even when the check box CB of the execution screen DD is forgotten to be checked, the acceptance judgment can be performed.

In the present embodiment, it is possible to set whether the acceptance judgment is performed collectively for a plurality of unit operation programs or for each unit operation program, and in a case where the setting performed collectively for the plurality of unit operation programs and the setting performed for each unit operation program overlap, the setting performed for each unit operation program is prioritized. By this, the acceptance judgment can be performed more accurately. The order of priority may be reversed.

While the control device and the control method of the present disclosure have been described with reference to the shown embodiments, the present disclosure is not limited thereto. Further, each step and each part of the control method and a fitting tool can be replaced with an arbitrary step and structure capable of exhibiting the same function. Furthermore, any step or structure may be added.

What is claimed is:

1. A control device comprising:
an acquisition section that acquires first information related to a tool mounted on a tip end section of a robot arm among a plurality of tools;
a judgment section that performs an acceptance judgment on whether the first information acquired by the acquisition section matches second information that is related to the tool and that was set in advance;
a drive control section that controls driving of the robot arm to start an operation of the robot arm when the judgment section judges that the first information and the second information match each other; and
a notification signal generation section that notifies an error when the judgment section judges that the first information and the second information do not match.

2. The control device according to claim 1, wherein
each of the first information and the second information includes position information of an origin of a coordinate system set for each tool.

3. The control device according to claim 2, wherein
the judgment section performs the acceptance judgment for each point that is the position information of the robot arm in an operation program.

4. The control device according to claim 2, wherein
the judgment section performs the acceptance judgment for each unit operation program included in the operation program executed by the robot arm.

5. The control device according to claim 2, wherein
the origin of the coordinate system set for each tool is a position eccentric from the tip end section of the robot arm.

6. The control device according to claim 1, wherein
the first information and the second information include information related to a type of the tool.

7. The control device according to claim 1, further comprising:
a selection section for selecting whether to perform the acceptance judgment by the judgment section.

8. The control device according to claim 2, wherein
whether to perform the acceptance judgment collectively for a plurality of unit operation programs or for each of the unit operation programs is settable, and
when a setting performed collectively for the plurality of unit operation programs and a setting performed for each of the unit operation programs overlap, the setting performed for each of the unit operation programs is prioritized.

9. A control method comprising:
an acquisition step of acquiring first information related to a tool mounted on a tip end section of a robot arm among a plurality of tools and
a judgment step of judging whether the first information acquired in the acquisition step matches second information that is related to the tool and that was set in advance, wherein
when matching the first information and the second information is judged in the judgment step, a driving step of controlling driving of the robot arm so as to start an operation of the robot arm is executed and
when not matching the first information and the second information is judged in the judgment step, a notification step of notifying an error is executed.
